(19) United States
(12) Patent Application Publication
(10) Pub. No.: US 2021/0334771 A1
(43) Pub. Date: Oct. 28, 2021

(54) SERVER, WALLET SYSTEM, COMPUTER READABLE RECORDING MEDIUM AND TRANSFER METHOD

(71) Applicant: TOYOTA JIDOSHA KABUSHIKI KAISHA, Toyota-shi (JP)

(72) Inventors: Kenji OKAZAKI, Toyota-shi (JP); Masato ENDO, Tokyo-to (JP); Mayumi KURITA, Tokyo-to (JP); Masashi TORITANI, Tokyo-to (JP); Kumiko MATSUURA, Tokyo-to (JP); Takayuki SHIKODA, Tokyo-to (JP); Masaaki OTSUKA, Kawasaki-shi (JP); Yoshikazu ISHII, Nagoya-shi (JP)

(73) Assignee: TOYOTA JIDOSHA KABUSHIKI KAISHA, Toyota-shi (JP)

(21) Appl. No.: 17/223,642

(22) Filed: Apr. 6, 2021

(30) Foreign Application Priority Data
Apr. 22, 2020 (JP) 2020-076228

(51) Int. Cl. G06Q 20/14; G06Q 20/36; G06Q 20/32

(52) U.S. Cl. CPC G06Q 20/14; G06Q 20/3223; G06Q 20/3678

(57) ABSTRACT

A server includes a processor including hardware, the processor being configured to: acquire pieces of information output from a first terminal possessed by a recipient who receives tip to a second terminal located within a range of a predetermined distance from the first terminal, the second terminal being possessed by a payer of the tip, and the pieces of information acquired by the processor including recipient identification information regarding the recipient, payer identification information regarding the payer, and tip amount information indicating a tip amount; perform a billing process of billing an account corresponding to a first settlement method designated by the payer identification information for electronic money equivalent to the tip amount information; and perform a transfer process of transferring the electronic money equivalent to the tip amount information to an account corresponding to a second settlement method designated by the recipient identification information.

The present application claims priority to and incorporates by reference the entire contents of Japanese Patent Application No. 2020-076228 filed in Japan on Apr. 22, 2020.

### BACKGROUND

The present disclosure relates to a server, a wallet system, a computer readable recording medium, and a transfer method.

As disclosed in JP 2019-139278 A, there is a known technique of performing a billing process of allowing a payer who pays a tip to pay the tip to a recipient who receives the tip. According to this technique, the payer verbally instructs the recipient to transmit, on a recipient terminal, a recipient identifier that identifies the recipient, to the payer terminal. Subsequently, an information processing device receives a payer identifier, the recipient identifier, and tip amount information transmitted from the payer terminal, and performs a billing process for the amount corresponding to the tip amount information onto the deposits in the account associated with the payer identifier. Thereafter, the information processing device performs a transfer process so that the amount corresponding to the tip amount information will be paid by virtual points to the account associated with the recipient identifier.

### SUMMARY

JP 2019-139278 A has stated that the payer needs to verbally instruct the recipient to transmit the recipient identifier on the recipient terminal. With this technique, the payer may not be hidden from the recipient, disabling privacy protection of the payer.

There is a need for a server, a wallet system, a computer readable recording medium, and a transfer method capable of protecting the privacy of the payer at the payment of the tip.

According to one aspect of the present disclosure, there is provided a server including a processor including hardware, the processor being configured to: acquire pieces of information output from a first terminal possessed by a recipient who receives tip to a second terminal located within a range of a predetermined distance from the first terminal, the second terminal being possessed by a payer of the tip, and the pieces of information acquired by the processor including recipient identification information regarding the recipient, payer identification information regarding the payer, and tip amount information indicating a tip amount; perform a billing process of billing an account corresponding to a first settlement method designated by the payer identification information for electronic money equivalent to the tip amount information; and perform a transfer process of transferring the electronic money equivalent to the tip amount information to an account corresponding to a second settlement method designated by the recipient identification information.

### BRIEF DESCRIPTION OF THE DRAWINGS

FIG. 1 is a diagram schematically illustrating a configuration of a wallet system according to an embodiment;

FIG. 2 is a block diagram illustrating details of individual components of a wallet system according to the embodiment;

FIG. 3 is a flowchart illustrating an outline of the processes executed by the wallet system according to the embodiment;

FIG. 4 is a view illustrating an example of an image displayed by a second terminal according to the embodiment; and

FIG. 5 is a view illustrating an example of another image displayed by a second terminal according to the embodiment.

### DETAILED DESCRIPTION

Hereinafter, a wallet system including a shop terminal according to an embodiment of the present disclosure will be described with reference to the drawings. Note that the present disclosure is not limited to the following embodiment.

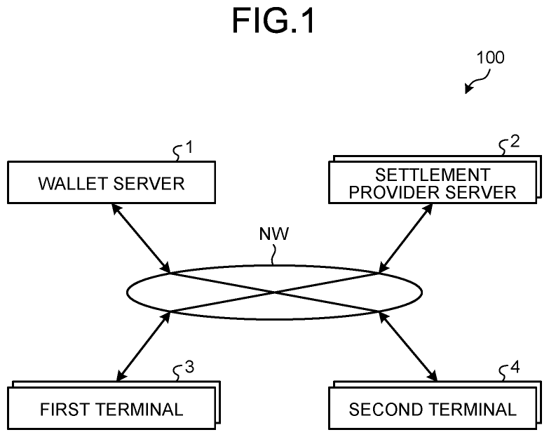

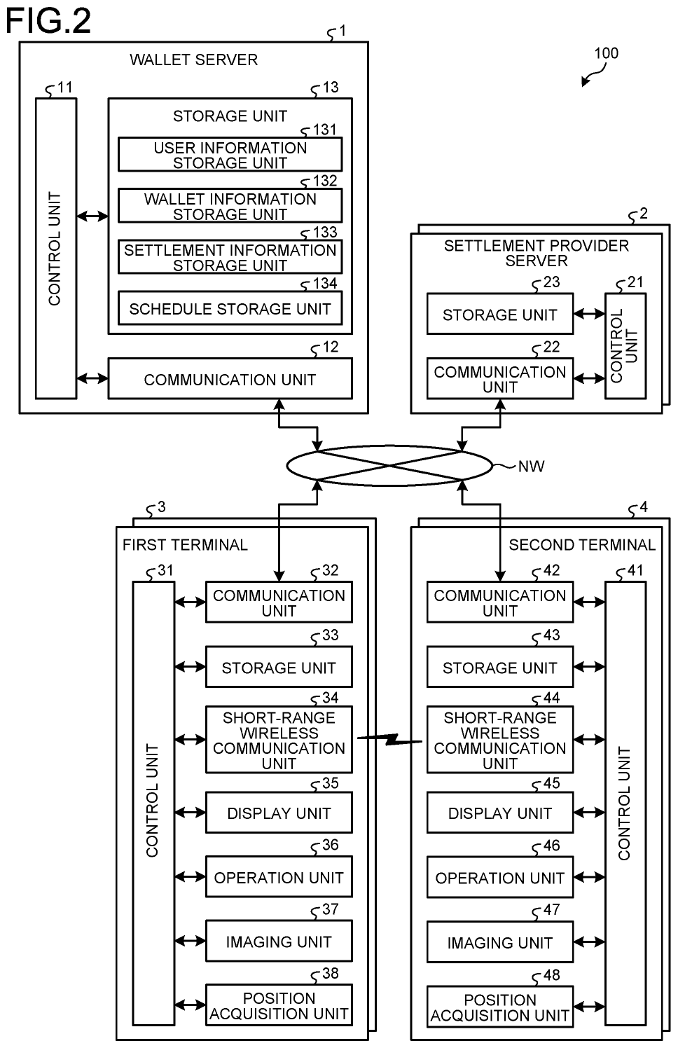

FIG. 1 is a diagram schematically illustrating a configuration of a wallet system according to the embodiment. FIG. 2 is a block diagram illustrating details of individual components of a wallet system according to the embodiment. A wallet system 100 illustrated in FIGS. 1 and 2 includes a wallet server 1, a settlement provider server 2, a first terminal 3, and a second terminal 4. The wallet system 100 has a configuration capable of mutual communication through the network NW. The network NW is composed of, for example, an internet network, a mobile phone network, or the like.

First, the configuration of the wallet server 1 will be described. The wallet server 1 is a server for comprehensively managing the wallet system 100. The wallet server 1 includes a control unit 11 (third processor), a communication unit 12, and a storage unit 13.

The control unit 11 controls individual component of the wallet server 1. The control unit 11 includes: a processor having hardware such as a Central Processing Unit (CPU) and a Field-Programmable Gate Array (FPGA); and memory (main storage unit) including Random Access Memory (RAM) and Read Only Memory (ROM). The control unit 11 loads the program stored in the storage unit 13 into a work area of the main storage unit and executes the program. Through execution of the program, the control unit 11 controls individual components.

The communication unit 12 is connected to the network NW such as the Internet, which is a public communication network, and communicates with each of the settlement provider server 2, the first terminal 3, and the second terminal 4 via the network NW. The communication unit 12 is implemented by using, for example, a Local Area Network (LAN) interface board, a wireless communication circuit for wireless communication, or the like.

The storage unit 13 stores various programs executed by the wallet server 1. The storage unit 13 is implemented by using a Hard Disk Drive (HDD), a Solid State Drive (SSD), or the like. Furthermore, the storage unit 13 includes a user information storage unit 131 for each of users in the wallet system 100, a wallet information storage unit 132, a settlement information storage unit 133, and a schedule storage unit 134.

The user information storage unit 131 stores user information related to a user who uses the wallet system 100. Example of the user information, information regarding the user who has registered to use the wallet system 100, such as user ID, password, user name, user contact information (for example, street address, telephone number, email address, etc.), user terminal information (device address, IP address, etc.), usage registration history, information related to a payment method registered as a deposit method, registration information indicating a plurality of settlement methods (settlement application names) registered as settlement methods for the first terminal 3, and a passcode at the time of settlement. The user ID and password stored in the user information storage unit 131 are used for an authentication process such as login to the wallet server 1.

The wallet information storage unit 132 stores wallet information related to the wallet of the wallet system 100. Examples of the wallet information include user ID (recipient identification information, payer identification information), an account corresponding to the settlement method designated by the user ID (recipient identification information, payer identification information), electronic money balance, electronic money deposit history, and electronic money usage history.

The settlement information storage unit 133 stores settlement information related to the settlement using the wallet system 100. Examples of the settlement information include user ID, a settlement method used for settlement (for example, electronic money payment, (contactless settlement), scan payment, code payment, etc.), and the settlement history.

The schedule storage unit 134 stores a recipient's schedule associated with the first terminal 3. Here, examples of the schedule include recipient information such as the date and time of a concert, the date and time of a street performance, a concert venue, a coupon ticket of shops, recommended products of the shop, and the shop number.

Next, the configuration of the settlement provider server 2 will be described. The settlement provider server 2 is a server for managing user's accounts and credit cards. The settlement provider server 2 is provided in financial institutions (for example, banks, credit association, credit unions, labor banks, etc.) and credit card companies. The settlement provider server 2 includes a control unit 21, a communication unit 22, and a storage unit 23. The control unit 21, the communication unit 22, and the storage unit 23 have the functions similar to the control unit 11, the communication unit 12, and the storage unit 13, respectively, and thus, detailed description thereof will be omitted.

The storage unit 23 stores account information and credit card information for each of users of the wallet system 100. Examples of the account information include the user's name, account number, account balance, deposit/withdrawal history, or the like. The credit card information includes, for example, the user's name, credit card number, credit card expiration date, usage limit amount, card usage history, or the like.

Next, the configuration of the first terminal 3 will be described. Examples of the first terminal 3 include smartphones, mobile phones, tablet terminals, wearable computers, personal computers, car navigation systems mounted on vehicles, or the like owned by the recipient of the tip. The first terminal 3 may be any terminal as long as it may exchange information with the wallet server 1.

The first terminal 3 includes a control unit 31 (first processor), a communication unit 32, a storage unit 33, a short-range wireless communication unit 34, a display unit (or display) 35, an operation unit 36, an imaging unit 37, and a position acquisition unit 38. The communication unit 32 has the function similar to the communication unit 12, and thus, detailed description thereof will be omitted.

The control unit 31 controls each of components of the first terminal 3. The control unit 31 includes a processor having hardware such as a CPU and a DSP, and memory (a main storage unit) formed of RAM, ROM, or the like. The control unit 31 loads the program stored in the storage unit 33 into the work area of the main storage unit and executes the program. Through execution of the program, the control unit 31 controls individual components.

A display control unit 311 controls the display content on the display unit 35. The display control unit 311 displays screens such as a member registration screen on which the user registers as a member, a login screen on which the user makes a login to the wallet system 100, a deposit screen on which the user performs deposit of electronic money to the wallet, and a settlement screen on which the user makes a settlement, or the like, on the display unit 35 based on the user's operations (touch operation, slide operation, pinch operation, flick operation, or the like) on the operation unit 36. In addition, the display control unit 311 causes each of screens to transition based on a user operation.

The storage unit 33 stores various types of screen data to be displayed on the display unit 35 by the display control unit 311. The storage unit 33 is actualized by using an HDD, an SSD, or the like. The storage unit 33 includes a user information storage unit 131, a wallet information storage unit 132, a settlement information storage unit 133, or the like, as necessary.

The short-range wireless communication unit 34 has a communication function conforming to the standards such as Near field radio communication (NFC), Bluetooth (registered trademark) Low Energy (BLE), and Infrared Data Association (IrDA). For example, when making electronic money payment, the first terminal 3 performs short-range wireless communication with the second terminal 4 through the short-range wireless communication unit 34.

The display unit 35 is actualized by using a liquid crystal display, an organic electroluminescent (EL) display, or the like, and displays various types of information and images under the control of the control unit 31.

The operation unit 36 is actualized by using a touch panel, a button, a switch, or the like, receives user's operation, and makes outputs corresponding to the received operation to the control unit 31.

The imaging unit 37 captures an image of a predetermined field of view, and outputs the captured image (image data) to the control unit 31. The imaging unit 37 is actualized by using one or more lenses and an image sensor such as a Charge Coupled Device (CCD) sensor or a Complementary Metal Oxide Semiconductor (CMOS) sensor.

The position acquisition unit 38 acquires the position information (terminal position information) regarding the current position of the first terminal 3 and outputs the acquired position information to the control unit 31. The position acquisition unit 38 is actualized by using a GPS sensor, receives signals from a plurality of GPS satellites and transmitting antennas, and acquires the position information of the first terminal 3 based on the received signals.

Next, the configuration of the second terminal 4 will be described. Examples of the second terminal 4 include smartphones, mobile phones, tablet terminals, wearable computers, personal computers, car navigation systems mounted on vehicles, or the like owned by the payer who pays the tip. The second terminal 4 may be any terminal as long as it may exchange information with the wallet server 1.

The second terminal 4 includes a control unit 41 (second processor), a communication unit 42, a storage unit 43, a short-range wireless communication unit 44, a display unit (or display) 45, an operation unit 46, an imaging unit 47, and a position acquisition unit 48. Note that the control unit 41, the communication unit 42, the storage unit 43, the short-range wireless communication unit 44, the display unit 45, the operation unit 46, the imaging unit 47 and the position acquisition unit 48 have functional configurations similar to the control unit 31, the communication unit 32, the storage unit 33, and the short-range wireless communication unit 34, the display unit 35, the operation unit 36, the imaging unit 37, and the position acquisition unit 38, respectively, and thus, detailed description thereof will be omitted.

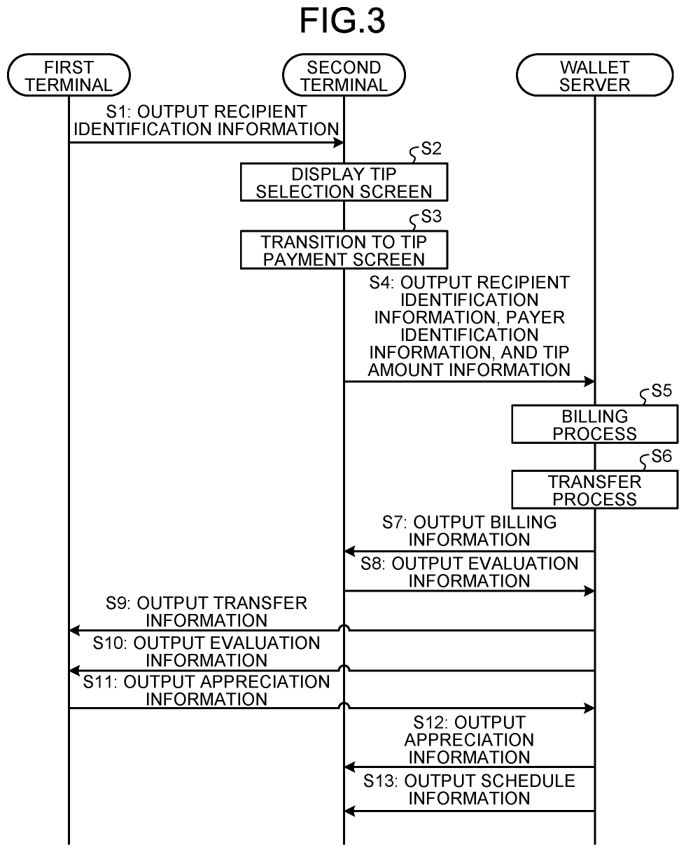

Next, the processes executed by the wallet system 100 will be described. FIG. 3 is a flowchart illustrating an outline of the processes executed by the wallet system 100. In the following, the first terminal 3 will be described as a terminal possessed by the recipient who receives the tip, and the second terminal 4 will be described as a terminal possessed by the payer who pays the tip. Furthermore, it is assumed that the first terminal 3 is provided in plurality, present within a predetermined range (for example, 100 m) from the second terminal 4.

As illustrated in FIG. 3, first, the control unit 31 of the first terminal 3 outputs recipient identification information within a predetermined range (for example, 100 mm) via the short-range wireless communication unit 44 (step S1). Here, the recipient identification information is information (user information) that identifies the recipient associated with the information (device address) that identifies the first terminal 3.

Subsequently, the control unit 41 of the second terminal 4 displays, on the display unit 35, a tip selection screen P1 including the plurality of pieces of recipient identification information received from each of the plurality of first terminals 3 received from within a predetermined range (step S2).

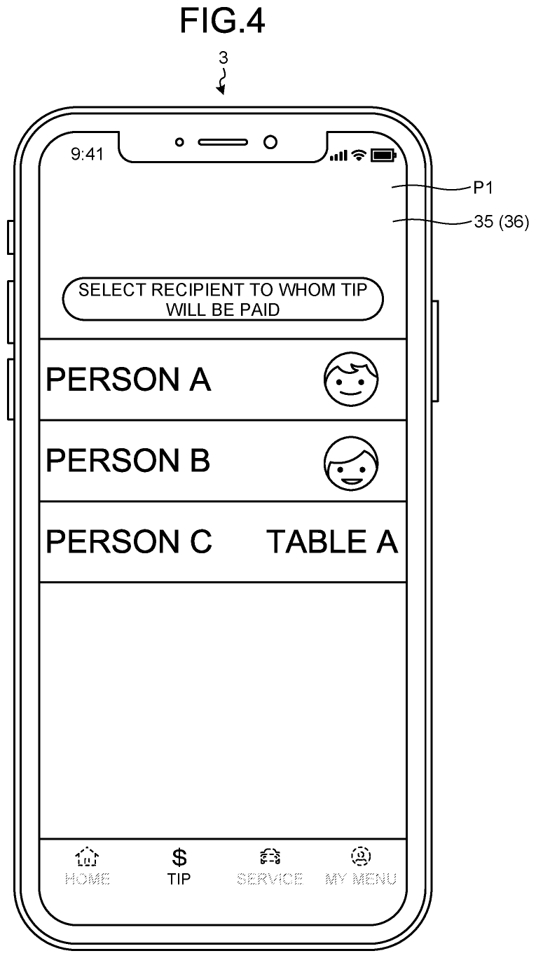

Specifically, as illustrated in FIG. 4, the control unit 41 of the second terminal 4 displays, on the display unit 45, the plurality of pieces of recipient identification information received from each of the plurality of first terminals 3 received from within a predetermined range. In this case, the control unit 41 of the second terminal 4 displays, on the display unit 35, a plurality of face icons, avatars, names, shop to which tips are paid, and table names (waiters reserved for the table) corresponding to the plurality of pieces of recipient identification information. In FIG. 4, the control unit 41 of the second terminal 4 performs display using a plurality of icons corresponding to a plurality of pieces of recipient identification information. Alternatively, it is allowable to change the order and display area on the tip selection screen P1 based on the distance from the second terminal 4 or reception strength. As a matter of course, the control unit 41 of the second terminal 4 may perform emphasized display of the plurality of pieces of recipient identification information based on the order of distance from the second terminal 4 or the reception strength. Here, the emphasized display means the display in which certain texts are made more prominent than other texts by enlarging the font, changing the font, changing the font color, using a special character in display, displaying avatars, reversing the background color (highlighting), or the like.

Thereafter, in a case where the user selects, via the operation unit 46, a recipient to whom the tip is to be paid, from among the plurality of pieces of recipient identification information displayed on the display unit 45, the control unit 31 of the first terminal 3 transitions to a tip payment screen (step S3).

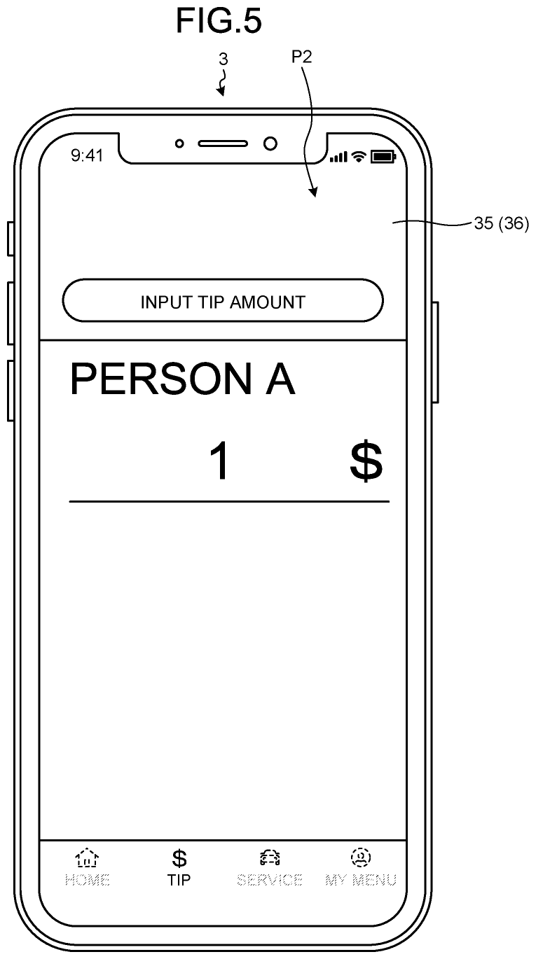

Specifically, as illustrated in FIG. 5, the control unit 41 of the second terminal 4 transitions from the tip selection screen P1 to a tip payment screen P2. In this case, the user inputs the tip amount via the operation unit 46. In FIG. 5, the user inputs 1 (dollar) as a tip for the recipient via the operation unit 36.

Subsequently, the control unit 41 of the second terminal 4 outputs, to the wallet server 1, the recipient identification information input from the first terminal 3, the payer identification information that identifies the user of the second terminal 4 who also is the payer of the tip, and the tip amount information indicating the tip amount input by the user via the operation unit 46 (step S4). Here, the payer identification information is information (user information) that identifies the payer associated with the information (device address) that identifies the second terminal 4.

Subsequently, the control unit 11 of the wallet server 1 performs a billing process based on the payer identification information and the tip amount information output from the second terminal 4 (step S5), and performs a transfer process based on the tip amount information and the recipient identification information (step S6).

Specifically, based on the payer identification information and the tip amount information, the control unit 11 of the wallet server 1 performs the billing process (settlement) of billing the account corresponding to a first settlement method designated in the payer identification information for the electronic money equivalent to the tip amount information. More specifically, based on the payer identification information and the tip amount information, the control unit 11 of the wallet server 1 instructs the settlement provider server 2 corresponding to the account of the first settlement method designated by the payer identification information to perform a billing process (settlement process) for the electronic money equivalent to the tip amount information, thereby billing (performing settlement with) the account of the first settlement method designated in the payer identification information for the tip amount.

Furthermore, based on the recipient identification information and the tip amount information, the control unit 11 of the wallet server 1 performs a transfer process of transferring, to the account corresponding to a second settlement method designated in the recipient identification information, the electronic money equivalent to the tip amount information. More specifically, based on the recipient identification information and the tip amount information, the control unit 11 of the wallet server 1 instructs the settlement provider server 2 corresponding to the account of the second settlement method designated by the recipient identification information to perform the transfer process (deposit process) for the electronic money equivalent to the tip amount information, thereby transferring (depositing) the tip amount to the account corresponding to the second settlement method designated in the recipient identification information. This allows the payer to pay the tip while protecting privacy of the payer.

Thereafter, the control unit 11 of the wallet server 1 outputs billing information indicating that the billing process is completed to the second terminal 4 (step S7). This allows the payer to know that the tip has been paid to the recipient.

Subsequently, the control unit 41 of the second terminal 4 outputs evaluation information indicating evaluation of the recipient input by the user via the operation unit 46, to the wallet server 1 (step S8). For example, the evaluation information is given as a message such as “Thank you” or “Awesome”. In a case where the user has not input evaluation information via the operation unit 46, the control unit 41 of the second terminal 4 may output evaluation information without a message to the wallet server 1.

Thereafter, the control unit 11 of the wallet server 1 outputs transfer information to the first terminal 3 (step S9), and then outputs the evaluation information to the first terminal 3 (step S10). This allows the recipient to know that the tip has been received. In addition, the recipient may receive evaluation information.

Subsequently, the second terminal 4 outputs appreciation information including an appreciation message for the payer input by the user via the operation unit 36, to the wallet server 1 (step S11).

Thereafter, the control unit 11 of the wallet server 1 outputs the appreciation information to the first terminal 3 (step S12), and outputs schedule information related to the recipient's schedule to the first terminal 3 (step S13). This allows the payer to receive the recipient's appreciation and schedule. After step S13, the wallet system 100 ends the present process.

According to the embodiment described above, the control unit 11 of the wallet server 1 acquires the recipient identification information, the payer identification information, and the tip amount information. Subsequently, the control unit 11 of the wallet server 1 performs a billing process of billing the account corresponding to the first settlement method designated by the payer identification information for the electronic money equivalent to the tip amount information. Thereafter, the control unit 11 of the wallet server 1 performs a transfer process of transferring, to the account corresponding to the second settlement method designated in the recipient identification information, the electronic money equivalent to the tip amount information. This allows the payer to protect own privacy.

Furthermore, according to the embodiment, in a case where the control unit 11 of the wallet server 1 has acquired a plurality of pieces of recipient identification information from the second terminal 4, the control unit 11 acquires the selection information to select one of the plurality of pieces of recipient identification information and performs the transfer process of transferring electronic money equivalent to the tip amount information to the account corresponding to the second settlement method designated by the recipient identification information selected by the selection information. Therefore, the payer may pay the tip to the desired recipient even when there is a plurality of recipients.

Furthermore, according to the embodiment, the control unit 11 of the wallet server 1 outputs billing completion information indicating the completion of the billing process to the second terminal 4. This allows the payer to know that the tip has been paid.

Furthermore, according to the embodiment, the control unit 11 of the wallet server 1 acquires the evaluation information including the message and evaluation for the recipient, and outputs the evaluation information to the first terminal 3. This allows the recipient to know the evaluation made by the payer who paid the tip.

Furthermore, according to the embodiment, the control unit 11 of the wallet server 1 outputs the transfer information to the first terminal 3. This allows the recipient to know that the tip has been received.

Furthermore, according to the embodiment, the control unit 11 of the wallet server 1 acquires the appreciation information including the appreciation message to the payer, and outputs the appreciation information to the second terminal 4. This allows the payer to receive an appreciation note from the recipient for the tip.

Furthermore, according to the embodiment, the control unit 11 of the wallet server 1 acquires schedule information of the recipient and outputs the schedule information to the second terminal 4. This allows the payer to know the schedule of the recipient.

Furthermore, in the wallet system according to the embodiment, the “unit” may be read as “circuit” or the like. For example, the control unit may be replaced with a control circuit.

Furthermore, the programs to be executed by the wallet system according to the embodiment are provided as file data of an installable format or an executable format in a state of being stored in a computer-readable recording medium such as a CD-ROM, flexible disk (FD), CD-R, Digital Versatile Disk (DVD), USB medium, flash drive, or the like.

Furthermore, the program to be executed by the wallet system according to the embodiment may be stored on a computer connected to a network such as the Internet so as to be downloaded via the network to be provided.

In the description of the flowcharts in the present specification, although the expressions “first”, “next”, “subsequently”, or the like are used to clarify a processing order of the steps, the processing order for carrying out the present embodiments shall not be defined uniquely by these expressions. That is, the processing order in each of the flowcharts described in the present specification may be changed unless it is inconsistent.

According to the present disclosure, there is an advantageous effect that the privacy of the payer may be protected at the payment of the tip.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server comprising
a processor comprising hardware, the processor being configured to:
acquire pieces of information output from a first terminal possessed by a recipient who receives tip to a second terminal located within a range of a predetermined distance from the first terminal, the second terminal being possessed by a payer of the tip, and the pieces of information acquired by the processor including recipient identification information regarding the recipient, payer identification information regarding the payer, and tip amount information indicating a tip amount;
perform a billing process of billing an account corresponding to a first settlement method designated by the payer identification information for electronic money equivalent to the tip amount information; and
perform a transfer process of transferring the electronic money equivalent to the tip amount information to an account corresponding to a second settlement method designated by the recipient identification information.

2. The server according to claim 1, wherein the processor is configured to:
acquire selection information to select one of a plurality of pieces of recipient identification information in a case where the processor has acquired the plurality of pieces of the recipient identification information from the second terminal; and
perform a transfer process of transferring electronic money equivalent to the tip amount information to the account corresponding to the second settlement method designated by the recipient identification information selected by the selection information.

3. The server according to claim 1, wherein the processor is configured to output billing completion information indicating completion of the billing process to the second terminal.

4. The server according to claim 3, wherein the processor is configured to:
acquire evaluation information including evaluation for the recipient; and
output the evaluation information to the first terminal.

5. The server according to claim 1, wherein the processor is configured to output transfer information indicating completion of the transfer of the tip to the first terminal.

6. The server according to claim 1, wherein the processor is configured to:
acquire appreciation information including an appreciation message for the payer; and
output the appreciation information to the second terminal.

7. The server according to claim 1, wherein the processor is configured to:
acquire schedule information regarding the recipient associated with the recipient identification information; and
transmit the schedule information to the second terminal.

8. A wallet system comprising:
a first terminal possessed by a recipient who receives a tip, the first terminal comprising
a first processor comprising hardware, the first processor being configured to output recipient identification information toward a range within a predetermined distance;
a second terminal possessed by a payer of a tip, the second terminal comprising
a second processor comprising hardware, the second processor being configured to
acquire the recipient identification information, and
output the recipient identification information, the payer identification information, and the tip amount information indicating a tip amount; and
a server comprising
a third processor comprising hardware, the third processor being configured to
acquire the recipient identification information, the payer identification information, and the tip amount information from the second terminal,
perform a billing process of billing an account corresponding to a first settlement method designated by the payer identification information for electronic money equivalent to the tip amount information, and
perform a transfer process of transferring electronic money equivalent to the tip amount information to an account corresponding to a second settlement method designated by the recipient identification information.

9. The wallet system according to claim 8, wherein
the second processor is configured to
acquire a plurality of pieces of the recipient identification information, and
output selection information to select one of the plurality of pieces of recipient identification information, and
the third processor is configured to
acquire the selection information in a case where the third processor has acquired the plurality of pieces of recipient identification information from the second terminal, and
perform a transfer process of transferring electronic money equivalent to the tip amount information to the account corresponding to the second settlement method designated by the recipient identification information selected by the selection information.

10. The wallet system according to claim 8, wherein the third processor is configured to output billing completion information indicating completion of the billing process to the second terminal.

11. The wallet system according to claim 10, wherein the third processor is configured to:
acquire evaluation information including evaluation for the recipient who has received a tip; and
output the evaluation information to the first terminal.

12. The wallet system according to claim 8, wherein the third processor is configured to output transfer information indicating completion of the transfer of the tip, to the first terminal.

13. The wallet system according to claim 8, wherein the third processor is configured to:
acquire appreciation information including an appreciation message for the payer; and
output the appreciation information to the second terminal.

14. The wallet system according to claim 8, wherein the third processor is configured to:
acquire schedule information regarding the recipient associated with the recipient identification information; and
transmit the schedule information to the second terminal.

15. A non-transitory computer-readable recording medium on which an executable program is recorded, the program causing a processor of a computer to execute:
acquiring pieces of information output from a first terminal possessed by a recipient who receives tip to a second terminal located within a range of a predetermined distance from the first terminal and possessed by a payer of the tip, the pieces of information to be acquired by the processor including recipient identification information regarding the recipient, payer identification information regarding the payer, and tip amount information indicating a tip amount;
performing a billing process of billing an account corresponding to a first settlement method designated by the payer identification information for electronic money equivalent to the tip amount information; and
performing a transfer process of transferring the electronic money equivalent to the tip amount information to the account corresponding to a second settlement method designated by the recipient identification information.

16. The non-transitory computer-readable recording medium according to claim 15, wherein the program causes the processor to execute:
acquiring selection information to select one of a plurality of pieces of recipient identification information in a case where the processor has acquired the plurality of pieces of the recipient identification information from the second terminal; and
performing a transfer process of transferring electronic money equivalent to the tip amount information to the account corresponding to the second settlement method designated by the recipient identification information selected by the selection information.

17. The non-transitory computer-readable recording medium according to claim 15, wherein the program causes the processor to execute outputting billing completion information indicating completion of the billing process to the second terminal.

18. The non-transitory computer-readable recording medium according to claim 17, wherein the program causes the processor to execute:
acquiring evaluation information including evaluation for the recipient; and
outputting the evaluation information to the first terminal.

19. The non-transitory computer-readable recording medium according to claim 15, wherein the program causes the processor to execute outputting transfer information indicating completion of the transfer of the tip to the first terminal.

20. A method of transferring, the method comprising:
acquiring pieces of information output from a first terminal possessed by a recipient who receives tip to a second terminal located within a range of a predetermined distance from the first terminal and possessed by a payer of the tip, the pieces of information acquired by the processor including recipient identification information regarding the recipient, payer identification information regarding the payer, and tip amount information indicating a tip amount;
performing a billing process of billing an account corresponding to a first settlement method designated by the payer identification information for electronic money equivalent to the tip amount information; and
performing a transfer process of transferring the electronic money equivalent to the tip amount information to the account corresponding to a second settlement method designated by the recipient identification information.
